(19) United States
(12) Patent Application Publication
(10) Pub. No.: US 2013/0076190 A1
(43) Pub. Date: Mar. 28, 2013

(54) WINDING FOR AN AC MACHINE

(71) Applicant: ABB Oy, Helsinki (FI)

(72) Inventors: Jukka JÄRVINEN, Helsinki (FI); Sami KANERVA, Vantaa (FI)

(73) Assignee: ABB Oy, Helsinki (FI)

(21) Appl. No.: 13/685,233

(22) Filed: Nov. 26, 2012

Related U.S. Application Data
(63) Continuation of application No. PCT/FI2011/050479, filed on May 25, 2011.

(30) Foreign Application Priority Data
May 25, 2010 (FI) 20105588

(51) Int. Cl. H02K 3/28

(52) U.S. Cl. CPC H02K 3/28
USPC 310/198

(57) ABSTRACT

A stator winding is disclosed for a multiple-phase alternating current machine with several parallel winding groups (U1, V1, W1; U2, V2, W2; U3, V3, W3), each of which can be supplied with separate power sources. Locations of the winding groups can be cyclically shifted when moving from one pole to another. The number of parallel winding groups (U1, V1, W1; U2, V2 ,W2 ;U3 ,V3 , W3) can be higher than two, and the number of poles of the alternating current machine can be an even figure that is a multiple of the number of winding groups.

### RELATED APPLICATION

This application claims priority as a continuation application under 35 U.S.C. §120 to PCT/FI2011/050479, which was filed as an International Application on May 25, 2011 designating the U.S., and which claims priority to Finnish Application 20105588 filed in Finland on May 25, 2010. The entire contents of these applications are hereby incorporated by reference in their entireties.

### FIELD

The disclosure relates to the winding of a multi-phase alternating current winding, for example, a stator winding with several parallel winding groups, each of which can be supplied with separate power sources, wherein the alternating current machine has several poles, and wherein the location of the winding groups is shifted cyclically when moving from one pole to another.

### BACKGROUND INFORMATION

Several winding systems are used in certain implementations of alternating current machines, making it possible to implement and group the windings in an appropriate manner, depending on the application. For example, the winding can be manufactured of windings that are connected in parallel together in one application and in series in another application. The technical specifications and features of the alternating current machine will naturally change.

In order to ensure the operation of the alternating current machine, the stator is fitted with two or more windings in some applications, in which case each winding can be sufficient to independently operate the machine. For example, the alternating current machine can include two identical windings, fitted to the same slots, in which case the second winding is taken into use after the first one fails. Such an arrangement can, however, waste much of the capacity of the alternating current machine.

The stator windings of a multipolar alternating current machine include groups, which can be formed into branches by connecting them either in parallel or series. Parallel branches can also be supplied from separate, mutually identical voltage sources. Coils in parallel branches should be located in the same point in the area of the pole in order for the voltage induced to them to be equal and cophasal.

In practice, high-power motor applications use several frequency converters to supply either one winding in parallel or several separate windings. If partial redundancy is provided in the system, mutually phase-displaced frequency converter supplies can be used. However, it is simpler if cophasal frequency converters controlled in parallel can be used.

When the alternating current machine is used with control by a frequency converter, the frequency converter can also be secured.

WO8403400 discloses the stator winding is divided into several channels, supplied separately and located in different points of the circumference of the stator. The different stator channels are electrically and magnetically separated from each other. When one or more channel and power sources supplying it are not in use, the part of the stator in question is correspondingly powerless.

A known three-phase alternating current machine is disclosed in WO2007128747, with a minimum of four poles and whose number of stator slots is the number of phases times the square of the number of poles or its multiple. In the publication, the number of winding systems equals the number of poles, and a frequency converter supplies each redundant winding system.

### SUMMARY

A winding for a multi-phase alternating current machine is disclosed having a plurality of poles, comprising: a plurality of parallel winding groups (U₁, V₁, W₁; U₂, V₂, W₂; U₃, V₃, W₃), each configured to be supplied by separate power sources, wherein locations of the winding groups are cyclically shifted from one pole to another, and wherein a number of the parallel winding groups (U₁, V₁, W₁; U₂, V₂, W₂; U₃, V₃, W₃) is higher than two, and is selected such that a number of poles of the alternating current machine will be an even number that is a multiple of the number of parallel winding groups.

A multi-phase alternating current machine is disclosed, comprising: a plurality of poles; and a plurality of parallel winding groups (U₁, V₁, W₁; U₂, V₂, W₂; U₃, V₃, W₃), each configured to be supplied by separate power sources, wherein locations of the winding groups are cyclically shifted from one pole to another, wherein a number of the parallel winding groups (U₁, V₁, W₁; U₂, V₂, W₂; U₃, V₃, W₃) is higher than two, and wherein a number of poles of the alternating current machine is an even number that is a multiple of the number of parallel winding groups.

### BRIEF DESCRIPTION OF THE DRAWINGS

In the following, the disclosure will be described in detail by referring to the drawings, where:

FIG. 1 illustrates an alternating current machine according to an exemplary embodiment of the disclosure, supplied by three frequency converters;

FIG. 2 illustrates the winding of an alternating current according to FIG. 1;

FIG. 3 illustrates an alternating current machine according to an exemplary embodiment of the disclosure, supplied by four frequency converters; and

FIG. 4 illustrates the winding of an alternating current according to FIG. 3.

### DETAILED DESCRIPTION

An alternating current machine according to an exemplary embodiment of the disclosure can include redundant stator windings, which utilize the properties and capacity of the alternating current machine and the control equipment controlling it more efficiently than before. In order to achieve this, exemplary embodiments of the disclosure include a number of parallel winding groups being higher than two, and by the number of poles of the alternating current machine being an even number, and a multiple of the number of winding groups.

In an exemplary embodiment of the disclosure, the location of coils belonging to different groups regularly cycles in the area of the poles, and these coils are connected in series. When the number of slots per phase, per pole (i.e. in Finnish “Vakolukv”) is the same as the number of individual windings or its multiple, the branches belonging to different windings can be made identical electrically. The benefit of the rotating location of coils is in that if one supplying system is missing, a symmetric rotating magnetic field is generated in the air gap of the machine.

In the disclosure, the idea of parallel winding groups and frequency converters supplying them can be utilized in a novel way. For example, the disclosure can apply to cases where the number of poles is an even integer of N times the number of windings, wherein N is an integer with a minimum value of two, and where each winding of the alternating current machine is supplied by a frequency converter of its own.

According to an exemplary embodiment of the disclosure, the electric machine can be an electric machine including three winding groups supplied by three frequency converters, with the number of poles being N₁*3*2, wherein N₁ is an integer, such as an electric machine with 6, 12, or 18 poles. According to an exemplary embodiment of the disclosure, the electric machine can be an electric machine including four winding groups supplied by four frequency converters, with the number of poles being N₂*4*2, wherein N₂ is an integer of two or higher, such as an electric machine with 8, 12, 16, or 20 poles supplied by four frequency converters. If one frequency converter fails, ⅔ or ¾ of the nominal power will still remain in use correspondingly. Even a power higher than this can be used if a temperature increase higher than the dimensioning value is permitted temporarily for the alternating current machine and the frequency converters supplying it, for example, loading of a machine pursuant to temperature class F is allowed at a power exceeding dimensioning temperature increase class B.

According to an exemplary embodiment of the disclosure, the number of phases of the alternating current machine and the frequency converters supplying it can be a minimum of three. Besides a normal three-phase machine, the alternating current machine can also be a five-phase or other several-phase machine.

According to an exemplary embodiment of the disclosure, the winding of each winding group can be arranged into each pole.

An alternating current machine 2 according to an exemplary embodiment of the disclosure can include three winding systems 4, 6, 8, each including a three-phase winding. Winding system 4 can include phase windings U₁, V₁, W₁, supplied from frequency converter 10. Correspondingly, winding system 6 can include phase windings U₂, V₂, W₂, supplied from frequency converter 12 and winding system 8 can include phase windings U₃, V₃, W₃, supplied from frequency converter 14. Frequency converters 10, 12, and 14 are illustrated as adjustable inverters that generate a variable-frequency output voltage from direct current. It should be understood that direct current is generated from the electricity distribution network in a practical implementation using a known method. Frequency converters 10, 12, and 14 are independent devices that function independently of each other so that their operation is not dependent on the operation of the other parallel frequency converters. According to an exemplary embodiment of the disclosure, the frequency converters can be controlled in a synchronized way, so their output frequencies and output voltages are essentially the same.

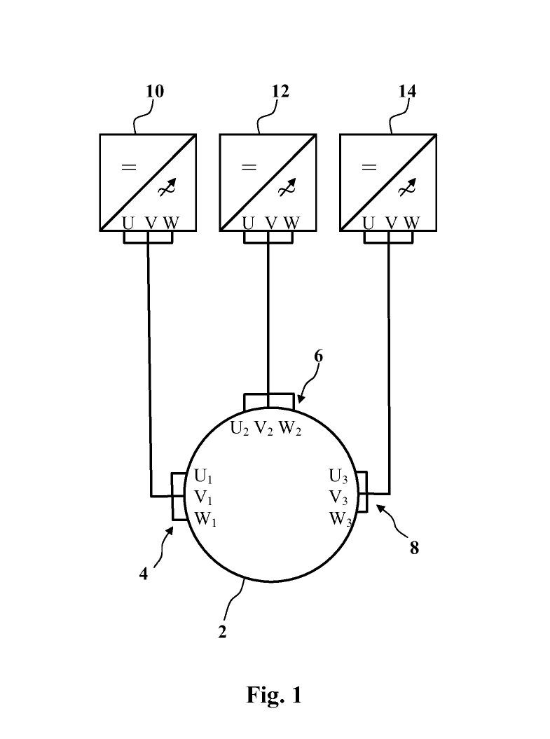

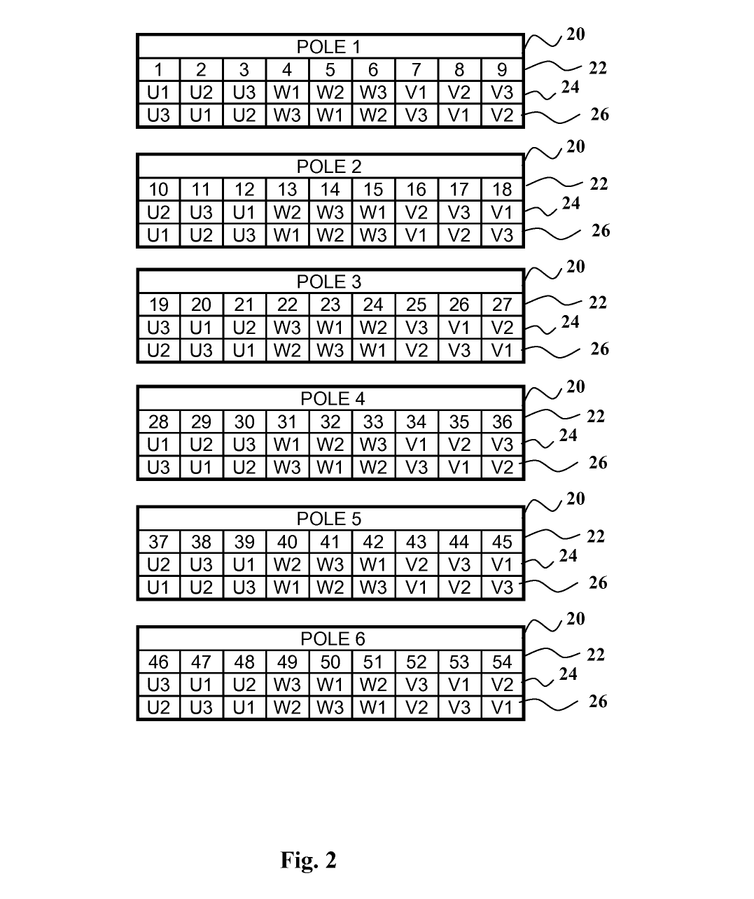

The table in FIG. 2 is a schematic diagram of the distribution of windings in the alternating current machine stator slots in a system according to FIG. 1 in an exemplary embodiment of the disclosure, where the alternating machine has six poles evenly distributed along the circumference of the stator. In FIG. 2, the number of the pole is indicated at the top on line 20 for each pole. Line 22 contains the running number 1-54 of the slot. Line 24 indicates the symbol of the phase winding fitted to the upper layer of the slot, and line 26 indicates the symbol of the phase winding fitted to the lower layer. The alternating current machine includes a full pitch winding including three winding groups, marked with the phase windings Uᵢ, Vᵢ and Wᵢ, wherein i is 1, 2, and 3. The number of poles of the alternating current machine is two times the number of winding systems, or six. The slot factor of a stator illustrated in FIG. 2, i.e. number of slots per phase and pole, is three. Phase windings of winding groups around pole 1, slots 1-9, are located in phases in the upper layer in the order of the winding group numbering 1, 2, 3. Around pole 2, slots 10-18, the winding groups are shifted by one slot, with the phase windings of the winding groups located in the order 2, 3, 1. Around pole 3, slots 19-27, the phase windings are located in the order 3, 2, 1. Correspondingly, around poles 4, 5, and 6, the location of the phase windings at slots 28-54 correspond with the locations of poles 1, 2, and 3. With regard to the lower layer of the slots, the winding phases Uᵢ, Vᵢ, and Wᵢ of the winding groups are recycled in the same way.

If a winding group is not in use in an exemplary embodiment of the disclosure illustrated in FIG. 2 due to a failure of the winding or the power source supplying it, the alternating current machine can operate with its original dimensioning specifications with ⅔ power. If short-term or temporary overload of 50 percent is permitted for the alternating current machine and the power supply supplying it, the machine can correspondingly be used at its dimensioning power in the short or long term.

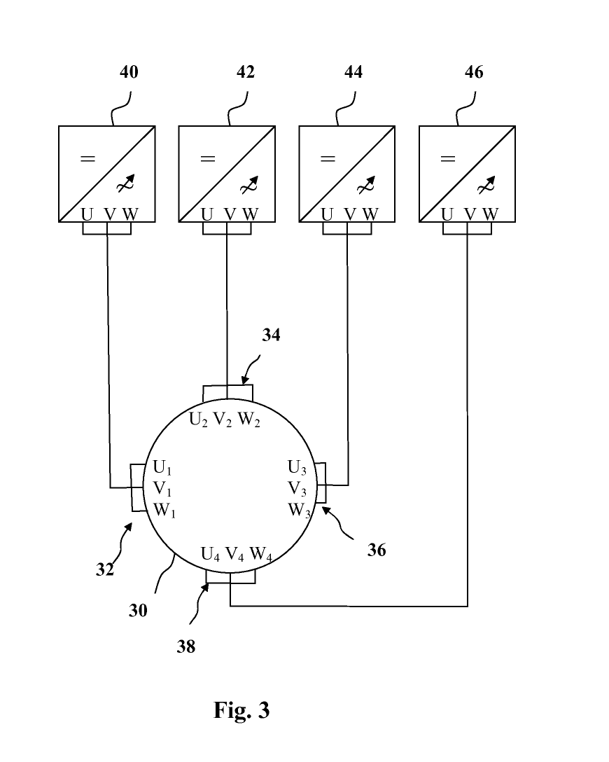

FIG. 3 illustrates an exemplary embodiment according to the disclosure, wherein four frequency converters supply an alternating current machine with four parallel winding systems. An alternating current machine 30 according to FIG. 3 can include four winding systems 32, 34, 36, and 38, each including three-phase winding. Winding system 32 can include phase windings U₁, V₁, W₁, supplied from frequency converter 40. Correspondingly, winding system 34 can include phase windings U₂, V₂, W₂, supplied from frequency converter 42, and winding system 36 can include phase windings U₃, V₃, W₃, supplied from frequency converter 44, and winding system 38 can include phase windings U₄, V₄, W₄, supplied from frequency converter 46. Frequency converters 40, 42, 44, and 46 correspond with frequency converters 10, 12, and 14 of FIG. 1 in terms of their properties.

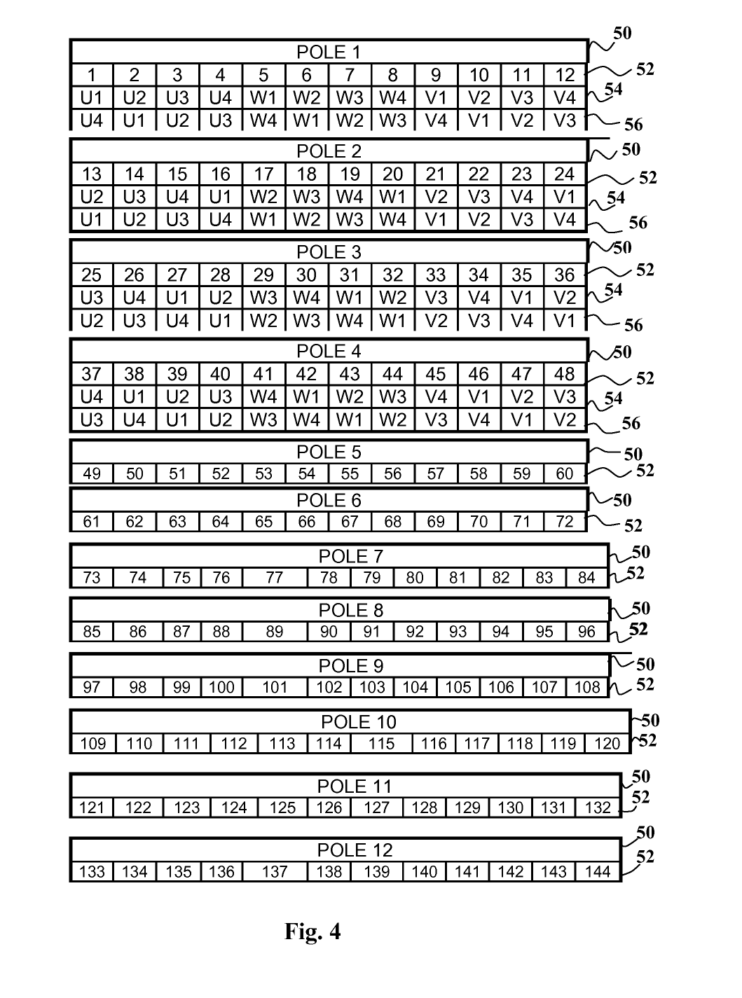

The table in FIG. 4 is a schematic diagram of the distribution of windings in the alternating current machine stator grooves in a system according to FIG. 3 in an exemplary embodiment of the disclosure, where the alternating machine has 12 poles evenly distributed along the circumference of the stator. In the table in FIG. 4, the number of the pole is indicated at the top on line 50 for each pole. Line 52 contains the running number 1-144 of the slot. Line 54 indicates the symbol of the phase winding of the winding group fitted to the upper layer of the slot, and line 56 indicates the symbol of the phase winding of the winding group fitted to the lower layer. The alternating current machine can include a full pitch winding with four winding groups, marked with the phase windings Uᵢ, Vᵢ, and Wᵢ, wherein i is 1, 2, 3, and 4. The number of poles of the alternating current machine is three times the number of winding systems, or 12. The slot factor of a stator illustrated in FIG. 4, i.e. number of slots per phase and pole, is four. Around pole 1, slots 1-12, the phase windings of the winding groups are located in the upper layer in the order of the winding group number 1, 2, 3, 4. Around pole 2, slots 13-24, the phase windings of the winding groups are shifted by one slot, with the phase windings of the winding groups located in the order 2, 3, 4, 1. Around pole 3, slots 25-36, the phase windings of the winding groups are located in the order 3, 4, 1, 2. Around pole 4, slots 37-48, the phase windings of the winding groups are located in the order 4, 1, 2, 3. Around poles 5, 6, 7, and 8, at slots 49-96, and correspondingly around poles 9, 10, 11, and 12, at slots 97-144, the locations of the phase windings of the winding groups correspond with the locations of the phase windings of the winding groups at poles 1, 2, 3, and 4, and they are not separately illustrated. In the lower layer of the slots, the winding phases Uᵢ, Vᵢ, and Wᵢ are recycled in the same way.

If a winding group is not in use in an exemplary embodiment of the disclosure illustrated in FIG. 4 due to a failure of the winding or the power source supplying it, the alternating current machine can operate with its original dimensioning specifications with ¾ power. If short-term or temporary overload of 33 percent is permitted for the alternating current machine and the power supply supplying it, the machine can correspondingly be used at its dimensioning power in the short or long term. In the exemplary embodiment illustrated in FIG. 4, the failure of two winding groups or power sources supplying them allows the use of the system at at one-half of its dimensioning power continuously.

In the above, the disclosure has been described with the help of certain embodiments. However, the scope may vary, for example, instead of the three-phase alternating current machine and frequency converter illustrated, the number of phases of the system may also be higher. An alternating current machine according to the disclosure can function, for example, both as a motor and as a generator.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A winding for a multi-phase alternating current machine having a plurality of poles, comprising:
a plurality of parallel winding groups (U₁, V₁, W₁; U₂, V₂, W₂; U₃, V₃, W₃), each configured to be supplied by separate power sources, wherein locations of the winding groups are cyclically shifted from one pole to another, and wherein a number of the parallel winding groups (U₁, V₁, W₁; U₂, V₂, W₂; U₃, V₃, W₃) is higher than two, and is selected such that a number of poles of the alternating current machine will be an even number that is a multiple of the number of parallel winding groups.

2. The winding according to claim 1, configured for an alternating current machine that is to have at least three phases.

3. The winding according to claim 1, wherein the number of parallel winding groups (U₁, V₁, W₁; U₂, V₂, W₂; U₃, V₃, W₃) is three, and the winding groups are configured for a number of poles of an alternating current machine which is N₁*3*2, wherein N₁ is an integer.

4. The winding according to claim 1, wherein the number of parallel winding groups (U₁, V₁, W₁; U₂, V₂, W₂; U₃, V₃, W₃; U₄, V₄, W₄) is four, and the winding groups are configured for a number of poles of an alternating current machine which is N₂*4, wherein N₂ is an integer of two or higher.

5. The winding according to claim 1, wherein a winding of each winding group (U₁, V₁, W₁; U₂, V₂, W₂; U₃, V₃, W₃) is configured to be arranged into a pole of an alternating current machine.

6. A multi-phase alternating current machine, comprising:
a plurality of poles; and
a plurality of parallel winding groups (U₁, V₁, W₁; U₂, V₂, W₂; U₃, V₃, W₃), each configured to be supplied by separate power sources, wherein locations of the winding groups are cyclically shifted from one pole to another, wherein a number of the parallel winding groups (U₁, V₁, W₁; U₂, V₂, W₂; U₃, V₃, W₃) is higher than two, and wherein a number of poles of the alternating current machine is an even number that is a multiple of the number of parallel winding groups.

7. The multi-phase alternating current machine according to claim 6, comprising:
separate power sources for each of the plurality of parallel winding groups (U₁, V₁, W₁; U₂, V₂, W₂; U₃, V₃, W₃).

8. The winding for a multi-phase alternating current machine according to claim 1, wherein the number of parallel winding groups (U₁, V₁, W₁; U₂, V₂, W₂; U₃, V₃, W₃) is three, and the number of poles of an alternating current machine which is N₁*3*2, wherein N₁ is an integer.

9. The multi-phase alternating current machine according to claim 6, wherein the alternating current machine has at least three phases.

10. The multi-phase alternating current machine according to claim 6, wherein the number of parallel winding groups (U₁, V₁, W₁; U₂, V₂, W₂; U₃, V₃, W₃; U₄, V₄, W₄) is four, and wherein the number of poles of the alternating current machine is N₂*4, wherein N₂ is an integer of two or higher.

11. The multi-phase alternating current machine according to claim 6, wherein a winding of each winding group (U₁, V₁, W₁; U₂,V₂, W₂; U₃, V₃, W₃) is arranged into each pole of the alternating current machine.
